(19) United States
(12) Patent Application Publication
(10) Pub. No.: US 2009/0296118 A1
(43) Pub. Date: Dec. 3, 2009

(54) INFORMATION PROCESSING APPARATUS, METHOD, AND MEDIUM STORING PROGRAM

(75) Inventor: Keiko Tsukamoto, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/465,943

(22) Filed: May 14, 2009

(30) Foreign Application Priority Data
May 28, 2008 (JP) 2008-140036

(51) Int. Cl. H04N 1/60

(52) U.S. Cl. 358/1.9

(57) ABSTRACT

An information processing apparatus for determining presence/absence of a measurement error when measuring color characteristics of a plurality of patches laid out on a chart, acquires measurement values of the plurality of patches, acquires color differences by comparing each of the measurement values of the plurality of patches and each of predetermined reference values of the plurality of patches, and determines the presence/absence of the measurement error using the acquired color differences.

### BACKGROUND OF THE INVENTION

1. Field of the Invention

The present invention relates to an information processing apparatus, a method for measuring the colors of patches and a medium storing a program.

2. Description of the Related Art

In recent years, in addition to personal computers, image digital devices such as color printers, digital cameras, digital video cameras, monitors, and projectors as peripheral devices have remarkably prevailed. Especially, in printers, as the printer main bodies have gained higher performance, the request level for color matching of users is growing. For example, applications of printing are expanded like commercial printing of corporate posters and brochures, photo printing of snapshots and the like by end users in home, and so forth. Of such applications, in the scene of commercial printing, businesses that handle actual printed materials such as posters and brochures as commercial products require a color matching technique with higher precision.

In order to realize high-precision color matching, digital devices used for reproduction are required to have stable characteristics. Also, as is known, printing is done using data represented by ICC (International Color Consortium) profiles so as to attain ideal color reproduction. However, print characteristics cannot become constant due to environmental variations of temperature and humidity, or process variations as a result of exchange of toners and paper sheets. As for printer profiles, even when profiles provided by printer manufacturers are used, since target color reproduction is different for individual users, desired color reproduction cannot often be obtained. To solve these problems, in recent years, manufacturers provide a profile creation tool that allows the user to create a desired profile.

When the profile creation tool is used, color patches are required to be actually printed using a printer, and these color patches are required to be measured using a measuring instrument, so as to acquire a target color space and a color space to be reproduced. Currently, measuring instrument manufacturers provide many compact and high-precision measuring instruments. However, these measuring instruments use various measurement methods: some instruments measure color patches for respective patches or lines, or some scanner-type measuring instruments automatically scan color patches for respective pages.

A measurement operation using such measuring instrument requires user's help. Therefore, many human-induced measurement errors occur. For example, in a measuring instrument that measures patches for respective lines, a line different from that to be measured may be erroneously measured, a printed material may be separated from the measuring instrument due to an operation error, and a wrong measurement start position may be set in some cases. As typified by such cases, in the measurement that requires user's help, the frequency of occurrence of measurement errors, i.e., acquisition failures of proper measurement values, is very high.

When a profile is created using these measurement values, the precision of that profile considerably drops, and a print result using that profile is far different from the expected one. In addition, the user cannot recognize measurement failures until a profile is created and actual printing is complete.

As a method of solving such problems, various techniques have been developed. In a technique disclosed in Japanese Patent Laid-Open No. 2005-61926, one patch sequence is measured a plurality of times to confirm the number of data, and when the confirmed number of data is larger or smaller than the assumed number of data, it is determined that a measurement error has occurred. Also, a plurality of measurement data are compared, and when their differences exceed a predetermined threshold, it is determined that a measurement error has occurred in a plurality of measurements. Also, in a technique disclosed in Japanese Patent Laid-Open No. 2002-94820, target data of each patch is internally held, and is compared with measurement data. If their difference exceeds a certain threshold, a warning indicating that a measurement error has occurred for that patch is issued to the user.

However, in Japanese Patent Laid-Open No. 2005-61926, since an identical patch is measured a plurality of times, the user's time cost increases, resulting in poor practicality. Also, in Japanese Patent Laid-Open No. 2002-94820, it is difficult to uniquely set a threshold used in determination, resulting in low detection precision. For example, if a small threshold is used, since the measurement is sensitive to delicate errors such as color reproduction differences due to device variations within the plane of a sheet like in-plane nonuniformity or different media, an error is detected even for a correctly measured patch. On the other hand, if a large threshold is used, an error cannot often be detected for a patch, the measurement of which has failed.

The aforementioned related arts especially do not consider any device variation factors such as variations of measurement values within the plane of a sheet like in-plane nonuniformity or measurement value differences depending on the types of media used in printing, when a measuring instrument that measures patches for respective lines is used. Therefore, since the aforementioned related arts are sensitive to an error for each patch, robustness is low.

### SUMMARY OF THE INVENTION

The present invention provides an information processing apparatus which can detect, with high precision, any measurement error that has occurred in a color patch measurement operation.

The present invention in its first aspect provides an information processing apparatus for determining presence/absence of a measurement error when measuring color characteristics of a plurality of patches laid out on a chart, comprising: a first measurement value acquisition unit configured to acquire measurement values of the plurality of patches; a color difference acquisition unit configured to acquire a plurality of color differences by comparing each of the measurement values and each of predetermined reference values of the plurality of patches; and a first determination unit configured to determine the presence/absence of the measurement error using the plurality of color differences.

The present invention in its second aspect provides an information processing method to be executed in an information processing apparatus for determining presence/absence of a measurement error when measuring color characteristics of a plurality of patches laid out on a chart, comprising: a measurement value acquisition step of acquiring measurement values of the plurality of patches; a color difference acquisition step of acquiring a plurality of color differences by comparing each of the measurement values and each of predetermined reference values of the plurality of patches; and a determination step of determining the presence/absence of the measurement error using the plurality of color differences.

The present invention in its third aspect provides a computer-readable medium storing an information processing program for determining presence/absence of a measurement error when measuring color characteristics of a plurality of patches laid out on a chart, the program making a computer function to: acquire measurement values of the plurality of patches; acquire a plurality of color differences by comparing each of the acquired measurement values and each of predetermined reference values of the plurality of patches; and determine the presence/absence of the measurement error using the plurality of acquired color differences.

According to the present invention, any measurement error that has occurred in a color patch measurement operation can be detected with high precision.

Further features of the present invention will become apparent from the following description of exemplary embodiments with reference to the attached drawings.

### BRIEF DESCRIPTION OF THE DRAWINGS

FIG. 1 is a block diagram showing the system arrangement including an information processing apparatus according to an embodiment of the present invention;

FIG. 2 is a flowchart showing the sequence of color patch measurement error determination processing;

FIG. 3 is a view showing an example of a user setting window of a profile creation application;

FIG. 4 is a view showing an example of a user interface that indicates a warning;

FIG. 5 is a flowchart showing the sequence of measurement error determination processing according to the first embodiment;

FIG. 6 is a view illustrating a table showing correspondence among patch data, target measurement values, measurement values, and color differences for respective patches;

FIG. 7 is a view showing an example of a patch layout according to this embodiment;

FIG. 8 is a flowchart showing the sequence of measurement error determination processing according to the second embodiment;

FIG. 9 is a flowchart showing the sequence of measurement error determination processing according to the third embodiment;

FIG. 10 is a view showing an example of a window displayed at the time of color patch measurement; and

FIG. 11 is a block diagram showing the arrangement of an information processing apparatus which is applied to the present invention.

### DESCRIPTION OF THE EMBODIMENTS

The best mode for carrying out the present invention will be described in detail hereinafter with reference to the drawings. Note that the same reference numerals denote the same components, and a repetitive description thereof will be avoided.

<Arrangement>

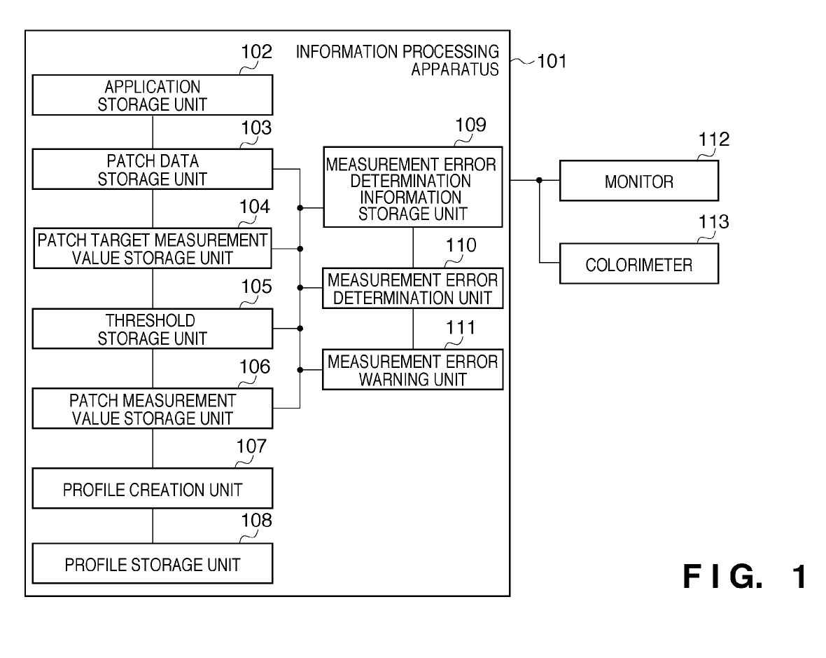

FIG. 1 is a block diagram showing the system arrangement including an information processing apparatus of this embodiment. As shown in FIG. 1, this system includes an information processing apparatus 101, application storage unit 102, patch data storage unit 103, patch target measurement value storage unit 104, threshold storage unit 105, patch measurement value storage unit 106, and profile creation unit 107. Also, this system includes a profile storage unit 108, measurement error determination information storage unit 109, measurement error determination unit 110, measurement error warning unit 111, and a monitor 112 and calorimeter 113, which are directly connected to a personal computer. As the information processing apparatus 101, for example, a general personal computer (PC) is used.

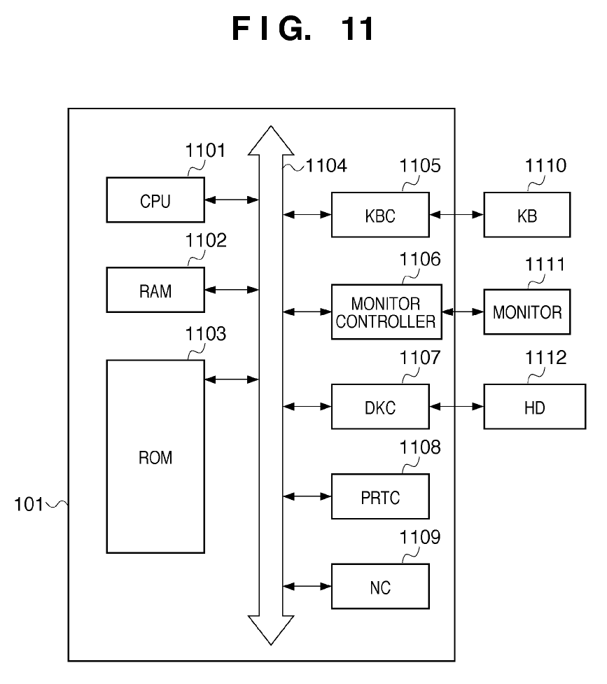

FIG. 11 is a block diagram showing the arrangement of the information processing apparatus which is applied to the present invention. A CPU 1101 executes an OS, general applications, and a program according to the present invention, which are stored in a ROM 1103 or are loaded from a hard disk (HD) 1112 onto a RAM 1102. The RAM 1102 serves as a main memory, work area, and the like of the CPU 1101. A keyboard controller (KBC) 1105 controls key inputs from a keyboard 1110 and a pointing device (not shown). A monitor controller 1106 controls display of a monitor 1111. A disk controller (DKC) 1107 controls accesses to the hard disk (HD) 1112 or the like, which stores a boot program, various applications, font data, user files, digital document files, and the like. A printer controller (PRTC) 1108 controls exchange of signals with a connected printer. A network controller (NC) 1109 is connected to a network, and executes communication control processing with other devices connected to the network. The CPU 1101 controls the aforementioned units via a system bus 1104.

A color patch measurement error determination method in the aforementioned arrangement will be described below. An application stored in the application storage unit 102 is launched based on an OS program that received a user's instruction, and is displayed on the monitor 112. In this embodiment, the following description will be given taking an application as an example for the sake of simplicity. However, the application may have an arbitrary form, or respective items of pre-set files and parameters may be described in a program without the intervention of any application.

The user makes the following operations on the launched application. Initially, the user designates patch data to be measured from now. The designated patch data are stored in the patch data storage unit 103. Now assume that patch data for 1000 patches of CMYK data are used in creation of a profile in the following description.

Next, the user designates target measurement values (to be also referred to as reference values) for the patch data. One or a plurality of types of prescribed target measurement values are internally held. Or the user may externally designate desired target data. As the target measurement values of patches in this embodiment, patch measurement values obtained when patches are printed using a medium of user's choice, and are measured properly may be used. Or generally used print reference values may be used as target measurement values. The target measurement values of patches acquired by the above method are stored in the patch target measurement value storage unit 104.

Then, the user sets a threshold used to determine whether or not a measurement error occurs. One or a plurality of types of thresholds according to determination levels are internally held. Or the user may externally designate a desired threshold. The threshold acquired by the above method is stored in the threshold storage unit 105.

After the user's settings, color patches are measured. Patch data which are measured on the application, or those which are measured in advance are acquired, and are stored in the patch measurement value storage unit 106. Then, information used to determine whether or not a measurement error has occurred is created using the data stored in the patch data storage unit, patch target measurement value storage unit, threshold storage unit, and patch measurement value storage unit, and is stored in the measurement error determination information storage unit 109. The measurement error determination unit 110 determines in practice whether or not a measurement error has occurred. Also, the user can select whether or not to execute determination.

As a result of determination, when it is determined that a measurement error has occurred, the measurement error warning unit 111 displays a warning to the user. When the warning is displayed, the user conducts a re-measurement only for patches, the measurement of which has failed. The re-measurement is conducted for a minimum required number of patches, i.e., for one patch or patches for one line. When the re-measurement is conducted, the patch measurement values stored in the patch measurement value storage unit 106 are overwritten, and the measurement error determination unit 110 determines a measurement error again by the same method as described above. On the other hand, when it is determined as a result of determination that no measurement error has occurred for all measurement data, the profile creation unit 107 creates a printer profile using the aforementioned patch measurement values, and stores the created profile in the profile storage unit 108.

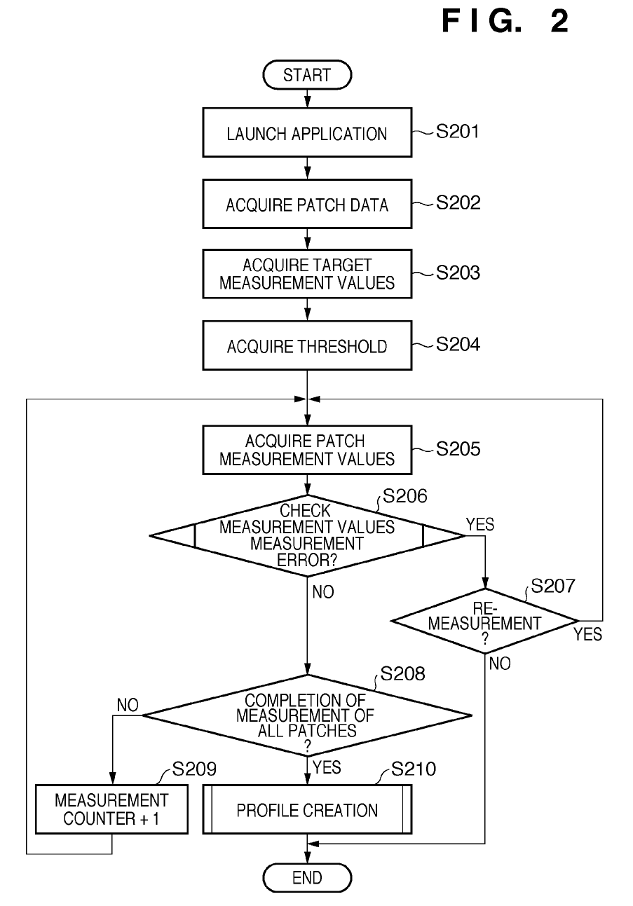

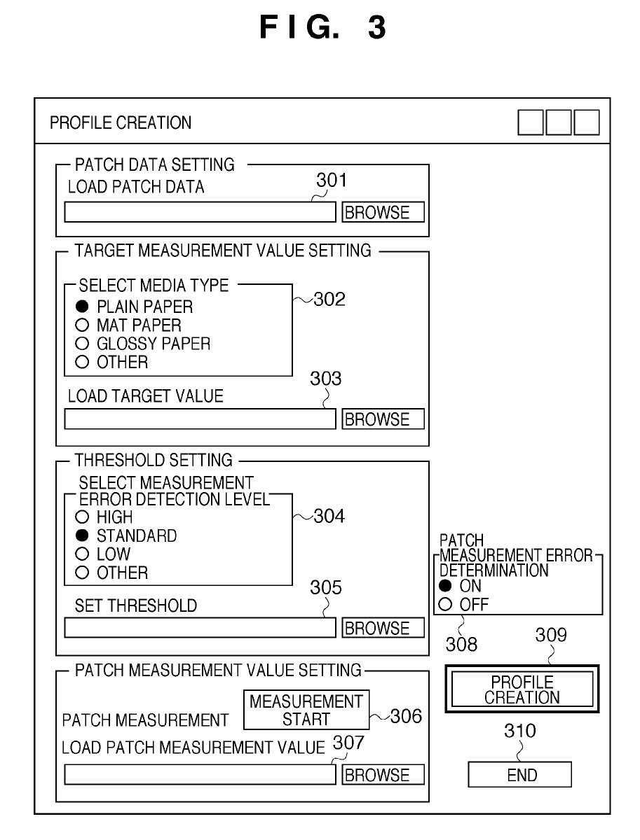

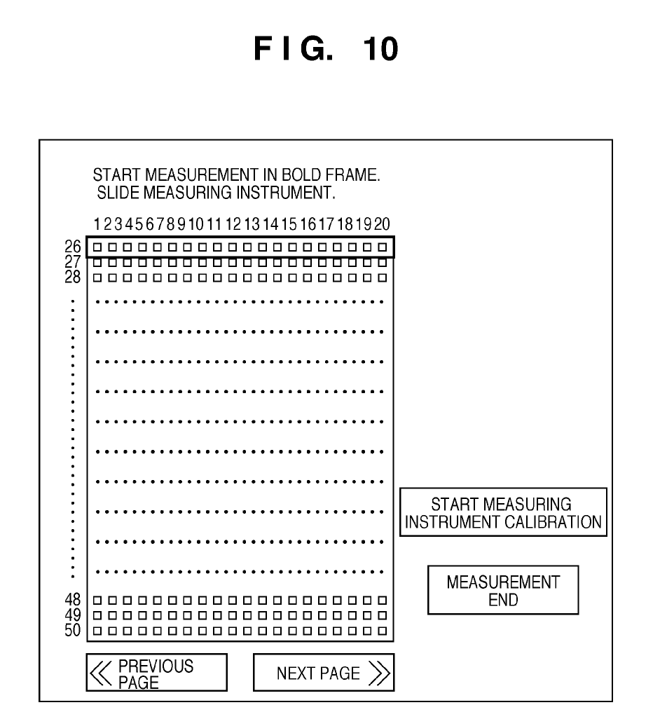

The color patch measurement error determination will be described in detail below with reference to FIGS. 2, 3, and 10. FIG. 2 is a flowchart showing the sequence of the color patch measurement error determination processing. FIG. 3 is a view showing an example of a user setting window of the profile creation application. FIG. 10 is a view showing an example of a window at the time of color patch measurement. Note that the application is exemplified only for the descriptive purpose of this embodiment, and is an example of the embodiment, as described above.

In step S201 shown in FIG. 2, the profile creation application stored in the application storage unit 102 is launched. After the application is launched, the window shown in FIG. 3 is displayed on the monitor 112.

In step S202, the user designates color patch data to be printed upon current profile creation in a field 301 shown in FIG. 3. In this embodiment, the designated patch data are CMYK data for 1000 patches, and are stored in the patch data storage unit 103.

In step S203, the user designates target measurement values for the patch data designated in step S202 in a field 303. Or the user may designate target measurement values by selecting a media type from a field 302. In this case, the media types and target measurement values are associated with each other in advance. Note that a plurality of different types of target measurement values may be internally held in association with printer models, ink characteristics, and the like in place of the media types. Alternatively, generally used reference values of the print industry such as JapanColor or JMPA may be uniquely set as target measurement values.

Assume that the user selects “plain paper” from the field 302 as target measurement values. In this case, measurement values obtained when patches defined by the CMYK data designated in step S202 are printed to have a given layout on plain paper sheets, and the printed patches are properly measured are set as the target measurement values.

Patch measurement values will be explained as “L*a*b*” data corresponding to CMYK patch data. The target measurement values may use values such as Lch, XYZ, and Jch that can describe device color characteristics in place of “L*a*b*”. The target measurement values acquired by the aforementioned method are stored in the patch target measurement value storage unit 104.

In step S204, the user sets a threshold used to determine whether or not a measurement error occurs. As shown in a field 304, thresholds are internally associated with high to low determination levels, and the user can select a desired threshold. Alternatively, the user may designate a file to be loaded that describes an arbitrary threshold in a field 305. A practical explanation about the threshold will be made later. The threshold information acquired by the aforementioned method is stored in the threshold storage unit 105.

In step S205, the information processing apparatus 101 acquires measurement values of the color patches which are output from the printer and are measured. When the user presses a button 306 shown in FIG. 3, a window shown in FIG. 10 pops up, and a communication between the calorimeter 113 and information processing apparatus 101 is started to allow color patch measurement control. Alternatively, the color patch measurement values measured in advance may be loaded by designating them in a field 307. The following description will be given under the assumption that the calorimeter 113 used in this embodiment is a handy type measuring instrument (or calorimeter) which repetitively measures patches for respective lines by a user's operation. However, the measuring instrument is not limited to the aforementioned mode, and various other models (e.g., an automatic measurement type) may be used as long as they can acquire measurement values for respective lines. The patch measurement values acquired by the aforementioned method are stored in the patch measurement value storage unit 106.

The measurement error determination unit 110 determines in step S206 using the information stored in the measurement error determination information storage unit 109 whether or not a measurement error has occurred during the acquisition process of the measurement values of the color patches. If a measurement error has occurred, the process advances to step S207. On the other hand, if no measurement error has occurred, the process advances to step S208. Details of the measurement error determination method will be described later. The measurement error determination method will be described below. The user can designate one of radio buttons in a field 308 to switch whether or not to execute determination. When the user sets a patch measurement error determination function to OFF in the field 308, the fields 302 to 305 are unselectable.

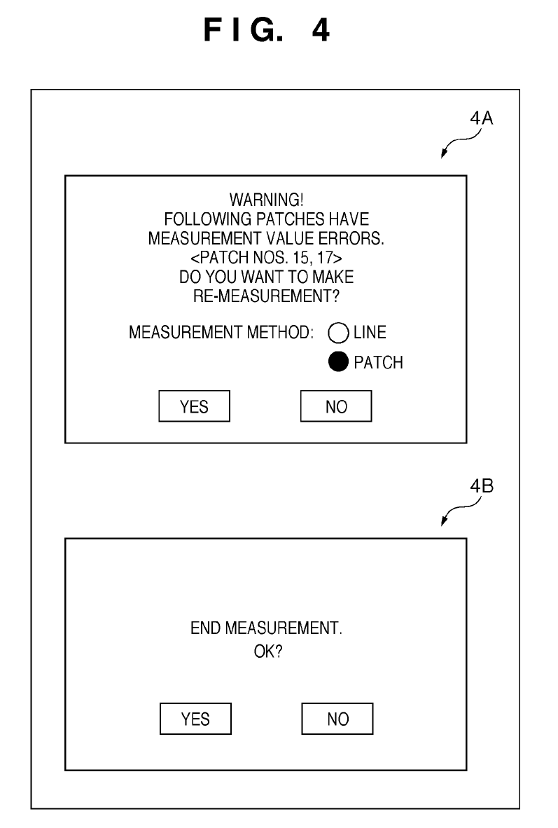

The user decides in step S207 if a re-measurement is made for patches corresponding to the measurement error determined in step S206. A measurement error is determined at the time of completion of a measurement for a predetermined unit. For example, a re-measurement of patches is made for a minimum required number of patches. In this embodiment, since a measurement is made for each line, one patch in which a measurement error has occurred during measurement, or all patches in that line are to be re-measured. The measurement error warning unit 111 displays a window 4A shown in FIG. 4 on the monitor 112 to prompt the user to decide whether or not to execute a re-measurement. If the user selects “YES” on the window 4A in FIG. 4 to decide to make a re-measurement, after he or she selects a measurement method on the window 4A in FIG. 4, the process returns to step S205 to re-measure the designated patch or patches.

On the other hand, if the user selects “NO” on the window 4A in FIG. 4 and decides not to make a re-measurement, the measurement error warning unit 111 displays a window 4B shown in FIG. 4 on the monitor 112 to the user, thus ending the application. Note that the above description uses a window display that prompts the user to decide at his or her will whether or not to make a re-measurement of patches. In this embodiment, the number of times of occurrence of measurement errors may be counted in the program, and when the count value is equal to or smaller than the predetermined number of times, the control may automatically enter a re-measurement sequence. Conversely, when measurement errors as many as the predetermined number of times or more have occurred, it may be determined that such errors are not caused by user measurement errors, but they are caused by print errors of patches due to a certain device trouble, thus ending the measurement sequence.

It is determined in step S208 if the measurement of all patches is complete. If the measurement of all patches is complete, the process advances to step S210. If the measurement of all patches is not complete yet, the process advances to step S209.

In step S209, a measurement counter is incremented by 1. In the following description of this embodiment, the measurement counter is a “line” counter. Hence, when the measurement counter is incremented by 1, the measurement value acquisition sequence of the next line starts in step S205.

When the user presses a button 309, the profile creation unit 107 creates a profile using the proper measurement values acquired via the processes until step S208 in step S210. The created profile is stored in the profile storage unit 108. As for profile creation, since a profile may have an arbitrary profile format and may use an arbitrary creation method, a detailed description thereof will not be given. In this embodiment, the profile corresponds to, for example, the CMYK data stored in the patch data storage unit 103 and the patch measurement values stored in the patch measurement value storage unit 106, and is described and saved in a format obtained by enumerating these data and values in turn.

When a user presses a button 310, the color patch measurement error determination processing and profile creation sequence end.

### First Embodiment

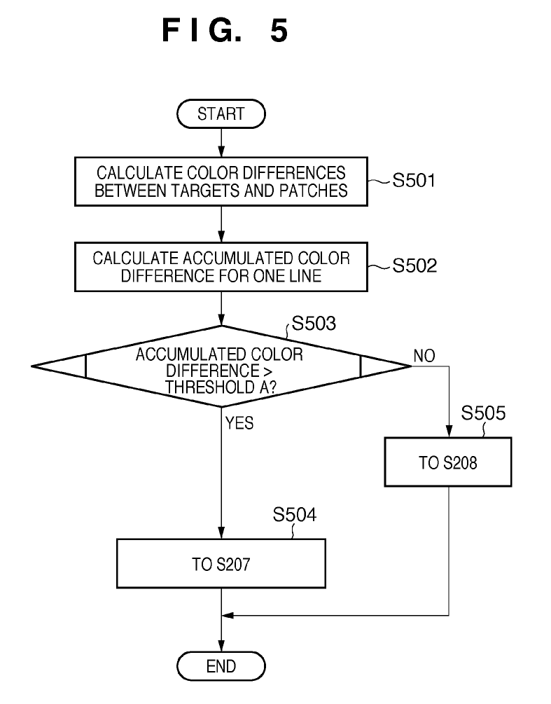

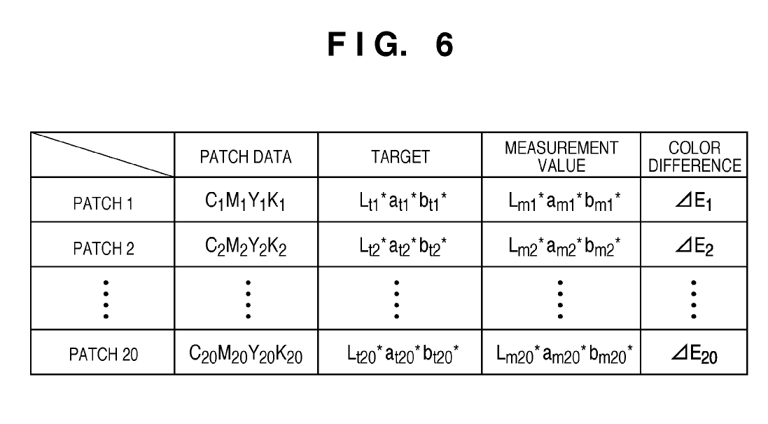

The first embodiment of the measurement error determination method in step S206 shown in FIG. 2 will be described below with reference to FIGS. 5 and 6. FIG. 5 is a flowchart showing the sequence of the measurement error determination processing according to the first embodiment of the present invention. FIG. 6 is a table showing correspondence among patch data, target measurement values, measurement values, and color differences for respective patches.

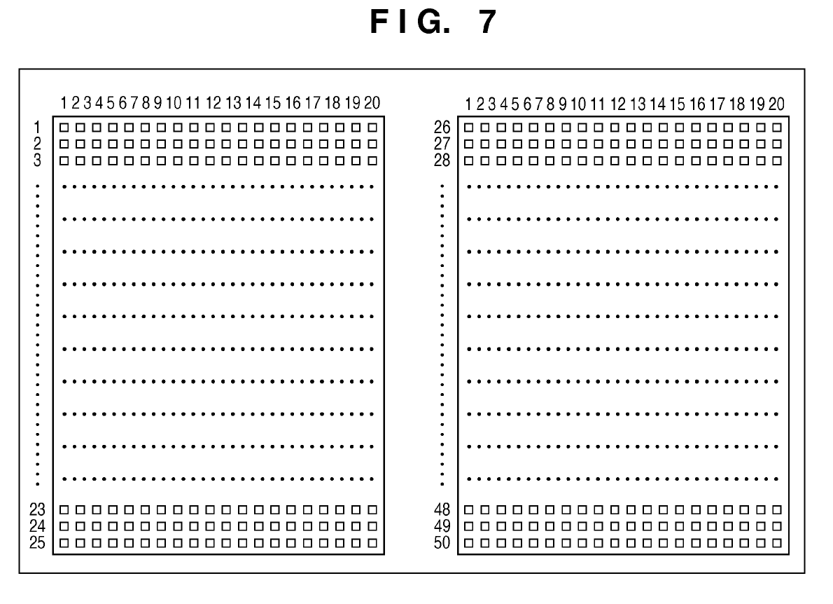

In this embodiment, the following description will be made under the assumption that the number of patches required to create a profile is 1000, and the format is CMYK data for the sake of simplicity. In one medium, a total of 500 patches (=25 lines×20 columns) are laid out on a color chart, and two media form a color chart used in color measurement, as shown in FIG. 7. In this embodiment, the measurement error determination processing is executed in real time when a measurement for one line by the user is completed.

In step S501 shown in FIG. 5, the patch data stored in the patch data storage unit 103, the target measurement values stored in the patch target measurement value storage unit 104, and the measurement values stored in the patch measurement value storage unit 106 are used. Using these data, color differences between the target measurement values and actual measurement values for respective patch data are calculated. Upon completion of the measurement for one line of patches by the user's operation, a total of 20 patch measurement values for one line are stored in the patch measurement value storage unit 106 at that time. Using these measurement values, color differences are calculated for respective patches.

Color differences between the target measurement values stored in the patch target measurement value storage unit 104 and the actually measured values stored in the patch measurement value storage unit 106 are calculated. In the calculation method, letting “Lₜ₁*aₜ₁*bₜ₁*” be the target measurement value of the first patch, and “Lₘ₁*aₘ₁*bₘ₁*” be the actually measured value of that patch, a color difference ΔE1 is calculated (an example of color difference acquisition) by:

ΔE1=((Lₜ₁*−Lₘ₁*)²+(aₜ₁*−aₘ₁*)²+(bₜ₁*−bₘ₁*)²)^{1/2} (1)

By the same sequence, a total of 20 color differences of respective patches for one line are calculated. The calculated information is stored in the measurement error determination information storage unit 109 in a format shown in FIG. 6.

In step S502, the color differences of patches for one line calculated in step S501 are accumulated. In this embodiment, since there are a total of 20 patches for one line, an accumulated color difference R1 for the first line is calculated by:

R1=ΔE1+ΔE2+ . . . +ΔE20 (2)

The calculated accumulated color difference R1 is stored in the measurement error determination information storage unit 109.

It is determined in step S503 whether or not the accumulated color difference calculated in step S502 is larger than a certain threshold A. The threshold can be arbitrarily decided in accordance with a user's request level for a measurement error. In this embodiment, the user's request level can be designated on the field 304. As shown in FIG. 3, the request level is selected from three choices “high”, “standard”, and “low”. Thresholds associated with these setting values are stored in advance in the threshold storage unit 105.

When the user wants to detect a measurement error with high precision, he or she selects “high” on the field 304. With this setting, assume that an average color difference allowable value per patch is set to be ΔE=1. Then, the accumulated color difference for one line is “1×20=20”. Hence, the threshold A set as “high” is 20.

Likewise, upon selection of “standard”, assume that an average color difference allowable value per patch is set to be ΔE=3 as a standard color difference in consideration of device variations such as in-plane nonuniformity. Then, the accumulated color difference for one line is “3×20=60”. Hence, the threshold A set as “standard” is 60.

Unlike the above two settings, when detection of a measurement error is not seriously considered, the user selects “low”. With this setting, assume that an average color difference allowable value per patch is set to be ΔE=5 as a relatively large value. Then, the accumulated color difference for one line is “5×20=100”. Hence, the threshold A set as “low” is 100.

In addition to the predetermined thresholds, the user can set an arbitrary threshold. When the user selects “other” on the field 304, the field 305 appears and allows the user to designate an arbitrary threshold setting file.

A measurement error is determined using the threshold set using any of the aforementioned methods. If the accumulated color difference for one line exceeds the threshold A, it is determined that a measurement error has occurred due to some cause, and the process advances to step S504. If the accumulated color difference for one line does not exceed the threshold A (i.e., the accumulated color difference is equal to or smaller than the threshold), it is determined that no measurement error has occurred, and the process advances to step S505.

In step S504, since it is determined that a measurement error has occurred, the process advances to step S207. The user determines whether or not to make a re-measurement, and if he or she decides to make a re-measurement, one patch in which a measurement error of which has occurred, or all patches in that line are re-measured. The subsequent processes are as have been described above.

In step S505, since it is determined that a measurement error has not occurred, the process advances to step S208. If the measurement of all patches is not complete yet, the control advances to the measurement of a line next to that which has been measured. Until the measurement of all patches is completed, the measurement operations and measurement error determination for all the number of patch lines are repeated. Accumulated color differences R1 to R50 for a total of 50 lines are calculated upon completion of the measurement for each line, and are used in measurement error determination. The subsequent processes are as have been described above.

The first embodiment using the accumulated color difference in association with the measurement error determination processing has been described. In the first embodiment, compared to a method that determines a measurement error by deciding a threshold for each patch, even when one line includes large and small color differences from the targets, they cancel each other, and the presence/absence of a measurement error is then determined. For this reason, when a measurement error is determined using the accumulated color difference, the robustness against a variation factor for each patch due to device variations such as in-plane nonuniformity can become high.

### Second Embodiment

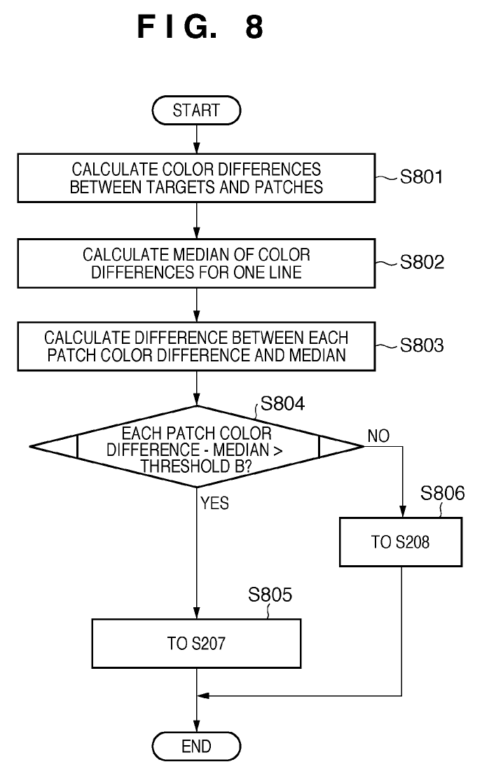

The second embodiment of the measurement error determination method in step S206 will be described below with reference to the flowchart of FIG. 8.

In step S801, color differences between the target measurement values and actually measured values are calculated for respective patch data as in the first embodiment. The calculated color difference information for one line is stored in the measurement error determination information storage unit 109 in the format shown in FIG. 6.

In step S802, a median of the color differences for one line calculated in step S801 is calculated. The median is a value located at the center when a predetermined number of data are sorted. The following description will be given under the assumption that the number of patches for one line is 20. Assume that color differences between the 20 target measurement value and actually measured values for one line are respectively {3, 3, 3, 4, 4, 10, 2, 3, 3, 3, 4, 2, 1, 3, 4, 2, 1, 1, 3, 4} in turn from the first patch to the 20th patch. These data are sorted in ascending order to obtain {1, 1, 1, 2, 2, 2, 3, 3, 3, 3, 3, 3, 3, 3, 4, 4, 4, 4, 4, 10}. In this case, since the number of data is an even number, an average of two numerical values located at the center is used as a median. That is, the median for the above data sequence is “(3+3)/2=3” (an example of median calculation).

In step S803, differences between the median for the data sequence for one line calculated in step S802, and the respective patch color differences are calculated. Currently, assume that the color differences between the target values and actually measured values for one line are {3, 3, 3, 4, 4, 10, 2, 3, 3, 3, 4, 2, 1, 3, 4, 2, 1, 1, 3, 4} in turn from the first patch to the 20th patch. In this case, the absolute values of the differences between the median (i.e., 3) calculated in step S802 and the respective patch color differences are respectively {0, 0, 0, 1, 1, 7, 1, 0, 0, 0, 1, 1, 2, 0, 1, 1, 2, 2, 0, 1} (an example of difference calculation).

It is determined in step S804 based on the differences between the patch color differences and the median calculated in step S803 if a measurement error has occurred. Assume that a threshold B is set to be 5. In a threshold decision method, as in the first embodiment, a value associated with the user's error detection request level or an arbitrary value can be set. The following description will be given using the absolute values {0, 0, 0, 1, 1, 7, 1, 0, 0, 0, 1, 1, 2, 0, 1, 1, 2, 2, 0, 1} of the differences between the patch color differences and the median calculated in step S803 in turn from the first patch to the 20th patch. In this case, the difference=7 of the sixth patch exceeds the threshold B (e.g., 5). Hence, the sixth patch is different from other patches, it is determined that a measurement error has occurred due to some user's operation error, and the process advances to step S805. On the other hand, if there is no difference that exceeds the threshold B, it is determined that no measurement error has occurred, and the process advances to step S806.

In step S805, since a measurement error has occurred, the process advances to step S207 shown in FIG. 2. In this step, the user determines whether or not to make a re-measurement, and if he or she decides to make a re-measurement, one patch in which a measurement error has occurred, or all patches in that line are re-measured. The subsequent processes are as have been described above.

In step S806, since no measurement error has occurred, the process advances to step S208 shown in FIG. 2. If the measurement of all patches is not complete yet, the control advances to the measurement of a line next to that which has been measured. Until the measurement of all patches is completed, the measurement operations and measurement error determination for all the number of patch lines are repeated. The subsequent processes are as have been described above, and a description thereof will not be repeated.

Note that this embodiment uses the median as a value used in determination. Upon calculation of a statistical value, other arbitrary statistical values such as an average value, variance, standard deviation, and mode as representative statistical values may be used. For example, a case will be explained below wherein the mode is adopted as a statistical value.

As in the above example, assume that color differences between 10 target measurement values and actually measured values for one line are respectively {4, 6, 6, 7, 1, 5, 6, 7, 6, 6} in turn from the first patch to the 10th patch. In this case, the mode is “6”. Then, the absolute values of the differences between the color differences and the mode are {2, 0, 0, 1, 5, 1, 0, 2, 0, 0}. If the threshold is set to be 3, it can be detected that a measurement error has occurred in the fifth patch. In this way, as in the case using the median as a statistical value, an abnormal value (measurement error) can be efficiently specified from all the measurement values.

The second embodiment using a statistical value represented by the median in association with the measurement error determination processing has been described. A large merit of determining a measurement error using the aforementioned method is as follows. The first embodiment has explained the method of determining a measurement error for one line. However, a measurement error for one patch, which cannot be detected by the above method, and has occurred in a case in which a patch and the measuring instrument were separated at an arbitrary position during measurement of patches for one line, can be detected.

### Third Embodiment

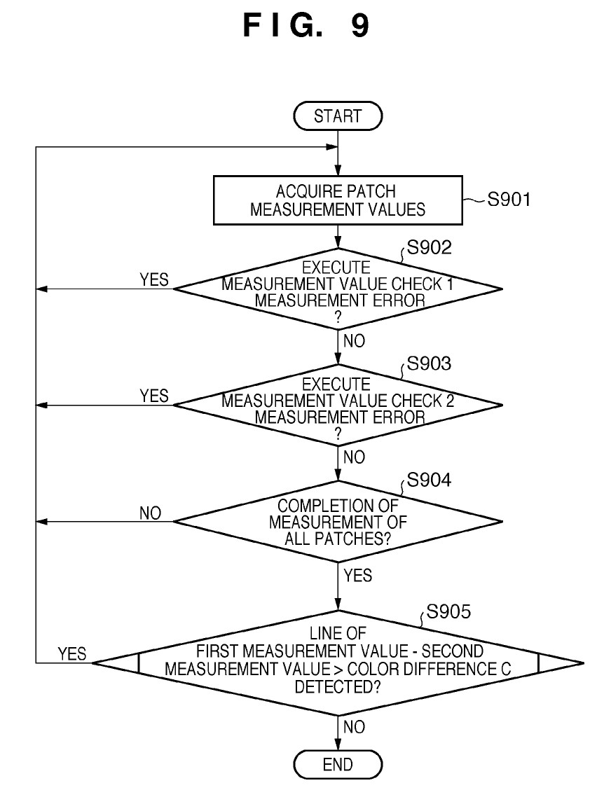

The third embodiment which detects a measurement error with high precision by combining the first and second embodiments will be described below with reference to FIG. 9.

In step S901, patch measurement values are acquired as in step S205.

It is determined in step S902 by the method of the first embodiment whether or not a measurement error has occurred. If it is determined that a measurement error has occurred, the process returns to step S901 to re-measure identical patches. On the other hand, if it is determined that no measurement error has occurred, the process advances to step S903. Note that the detailed measurement error determination method in the first embodiment is as has been described above.

If it is determined in step S902 that a measurement error has not occurred, second measurement error determination processing is executed in step S903. In this step, whether or not a measurement error has occurred is determined by the method of the second embodiment. If it is determined that a measurement error has occurred, the process returns to step S901 to re-measure identical patches. On the other hand, if it is determined that no measurement error has occurred, the process advances to step S904. Note that the detailed measurement error determination method in the second embodiment is as has been described above.

It is checked in step S904 if the measurement of all patches is complete. If the measurement of all patches is complete, the process advances to step S905 to enter a third measurement error determination sequence. On the other hand, if the measurement of all patches is not complete yet, the measurement counter is incremented by 1 in step S209, and patches for the next lines are measured in step S901.

Upon completion of the measurement of all patches, final measurement error determination processing for measurement errors which cannot be detected in steps S902 and S903 is executed in step S905.

The measurement of this embodiment is made for a chart including patches which are defined by identical CMYK data and are laid out at different positions in a medium to be printed. The reason why patches having data of identical color characteristics are laid out at different positions in the medium to be printed is to consider a case in which a proper patch measurement value cannot be acquired by a single measurement for one type of patch data due to a device trouble such as in-plane nonuniformity. A total of two measurement results are finally averaged, and the average is used in profile creation data.

The measurement data of all patches are acquired from the patch measurement value storage unit 106 (an example of second measurement value acquisition), and the first and second measurement results for two patches of identical CMYK data are compared. If no measurement error has occurred, it is expected that the two patches were measured to have nearly equal values except for device variation components. However, when the measurement of one of these patches has failed, it is expected that the two data have a large color difference.

Hence, the difference between the first and second measurement results for each of all patches is calculated, and it is determined whether or not the difference is larger than a predetermined threshold C. If the difference is larger than the threshold C, it is determined that either one of the two measurements has failed, and the process returns to step S901. On the other hand, if the difference is smaller than the threshold C, it is determined that both of the two measurements were properly done, thus ending the measurement error determination processing (an example of second determination).

However, when the measurement was made twice, since either one of two patches that has caused a measurement error during its measurement cannot be discriminated, only a total of two patches including the patch data or a total of two lines are re-measured in step S901.

The third embodiment has been described. The first embodiment detects a measurement error for each line, and the second embodiment detects a measurement error for each patch. In addition to these two embodiments, the third embodiment finally checks if a measurement error has occurred by comparing identical CMYK data after all patch data are finally obtained. As a result, a patch measurement error can be detected with higher precision.

This embodiment has explained the case in which identical patches are repetitively laid out twice. When the user wants to acquire patch measurement values with higher precision, if the number of times to be repetitively laid out is increased to three times and four times, the same processing can be executed. When each patch is laid out once, the other data used in comparison may be compared with a target measurement value which is internally held in advance (step S905). The target measurement value may be obtained by a method of designating patch data ideally measured under a certain condition. Alternatively, when the result measured upon creating the previous profile is used, the comparison result can be used as information required to decide whether or not color variations over time have occurred in a use device. In such case, it is desirable that calibration of the printer is executed to re-adjust to a device state suited to profile creation, and the printing and measurement operations of patches are then executed again to re-create a profile.

A computer-readable recording medium which records a program (information processing program) code of software that implements the functions of the aforementioned embodiments may be supplied to a system or apparatus. In such configuration, a computer (CPU or MPU) of that system or apparatus may read out and execute the program code stored in the recording medium. The object of the present invention can also be achieved by such configuration. In this case, the program code itself read out from a storage medium implements the functions of the aforementioned embodiments, and the storage medium which stores the program code constitutes the present invention.

As the storage medium used to supply the program code, for example, a flexible disk, hard disk, optical disk, magneto-optical disk, CD-ROM, CD-R, magnetic tape, nonvolatile memory card, ROM, and DVD can be used.

The present invention is not limited to a case in which the functions of the aforementioned embodiments are implemented when the computer executes the readout program code. An operating system (OS) or the like, which runs on the computer, may execute some or all actual processes based on an instruction of the program code, thereby implementing the functions of the aforementioned embodiments.

Furthermore, the program code read out from the storage medium may be written in a memory equipped on a function expansion board or unit, which is inserted in or connected to the computer. In this case, the present invention includes a case in which after the program code is written in the memory, a CPU or the like equipped on the function expansion board or unit executes some or all actual processes based on an instruction of the program code, thereby implementing the functions of the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-140036, filed May 28, 2008, which is hereby incorporated by reference herein in its entirety.

What is claimed is:

1. An information processing apparatus for determining presence/absence of a measurement error when measuring color characteristics of a plurality of patches laid out on a chart, comprising:
a first measurement value acquisition unit configured to acquire measurement values of the plurality of patches;
a color difference acquisition unit configured to acquire a plurality of color differences by comparing each of the measurement values and each of predetermined reference values of the plurality of patches; and
a first determination unit configured to determine the presence/absence of the measurement error using the plurality of color differences.

2. The apparatus according to claim 1, wherein the first determination unit determines the presence/absence of the measurement error using an accumulated color difference obtained by accumulating the plurality of color differences.

3. The apparatus according to claim 1, wherein the first determination unit determines the presence/absence of the measurement error using an accumulated color difference obtained by accumulating the plurality of color differences for each line.

4. The apparatus according to claim 2, wherein the first determination unit determines the presence/absence of the measurement error by comparing the accumulated color difference with a predetermined threshold.

5. The apparatus according to claim 4, wherein the first determination unit compares the accumulated color difference with the predetermined threshold, determines the presence of the measurement error when the accumulated color difference is larger than the threshold, and determines the absence of the measurement error when the accumulated color difference is not larger than the threshold.

6. The apparatus according to claim 1, wherein the first determination unit comprises:
a statistical value calculation unit configured to calculate a statistical value based on the color differences; and
a difference calculation unit configured to calculate differences between the statistical value and each of the color differences, and
the first determination unit determines the presence/absence of the measurement error using the differences calculated by the difference calculation unit.

7. The apparatus according to claim 6, wherein the statistical value calculation unit calculates a median of a sequence of the color differences.

8. The apparatus according to claim 6, wherein the statistical value calculation unit calculates a mode of a sequence of the color differences.

9. The apparatus according to claim 6, wherein the first determination unit compares each of the differences calculated by the difference calculation unit with a predetermined threshold, determines the presence of the measurement error when the difference is larger than the threshold, and determines the absence of the measurement error when the difference is not larger than the threshold.

10. The apparatus according to claim 1, further comprising:
a second measurement value acquisition unit configured to acquire measurement values of two patches, the patches are laid out at different positions on the chart and have identical color characteristics; and
a second determination unit configured to determine the presence/absence of the measurement error using the measurement values acquired by the second measurement value acquisition unit,
wherein after the first determination unit compares an accumulated color difference obtained by accumulating the color differences with a predetermined threshold, and determines the absence of a measurement error,
calculates differences between a median of a sequence of the color differences and each of the color differences, compares each of the differences with a predetermined threshold, and determines the absence of the measurement error,
the second determination unit calculates difference between two measurement values acquired by the second measurement value acquisition unit, compares the difference with a predetermined threshold, determines the presence of the measurement error when the difference is larger than the threshold, and determines the absence of the measurement error when the difference is not larger than the threshold.

11. The apparatus according to claim 1, further comprising a setting unit configured to set one of a patch, a reference value and a threshold.

12. An information processing method to be executed in an information processing apparatus for determining presence/absence of a measurement error when measuring color characteristics of a plurality of patches laid out on a chart, comprising:
a measurement value acquisition step of acquiring measurement values of the plurality of patches;
a color difference acquisition step of acquiring a plurality of color differences by comparing each of the measurement values and each of predetermined reference values of the plurality of patches; and
a determination step of determining the presence/absence of the measurement error using the plurality of color differences.

13. A computer-readable medium storing an information processing program for determining presence/absence of a measurement error when measuring color characteristics of a plurality of patches laid out on a chart, said program making a computer function to:
acquire measurement values of the plurality of patches;
acquire a plurality of color differences by comparing each of the acquired measurement values and each of predetermined reference values of the plurality of patches; and
determine the presence/absence of the measurement error using the plurality of acquired color differences.
